(19) United States
(12) Patent Application Publication
(10) Pub. No.: US 2026/0277317 A1
(43) Pub. Date: Sep. 17, 2026

(54) COMMUNICATION ASSISTANCE SYSTEM BASED ON GAZE TRACKING

(71) Applicant: SoftBank Group Corp., Tokyo (JP)

(72) Inventor: Tetsuya MATSUBAYASHI, Tokyo (JP)

(21) Appl. No.: 19/564,176

(22) Filed: Mar. 12, 2026

Related U.S. Application Data
(60) Provisional application No. 63/771,005, filed on Mar. 13, 2025.

(51) Int. Cl. G06F 3/01; G06T 7/70; G06V 40/19

(52) U.S. Cl. CPC G06F 3/013; G06T 7/70; G06V 40/19; G06T 2207/10048

(57) ABSTRACT

An eye-tracking unit detects a user's eye movements with high precision using an infrared camera or an optical sensor and identifies a gaze direction. A display unit dynamically displays selectable characters or images based on the user's gaze, and an audio output unit outputs selected content as audio with natural pronunciation. An AI processing unit learns a user's selection history and conversation history and predicts content to be displayed next.

### CROSS-REFERENCE TO RELATED APPLICATION

This application claims the benefit of priority from U.S. Provisional Patent Application No. 63/771,005, filed on Mar. 13, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to provide a means by which people with physical limitations or disabilities can efficiently and quickly input information and communicate without using their hands. Conventional input devices and communication means are premised on the use of hands and fingers, and this poses a significant barrier for users for whom this is difficult. In addition, although gaze input technology exists, challenges have remained in confirming selections and improving input speed.

This disclosure utilizes eye-tracking technology using a goggle-type device and enables a user to select characters or images with the movement of the user's eyes. Furthermore, by using AI to learn a user's personal preferences and daily conversation patterns and predicting frequently used words, phrases, and preferred images, the displayed options are dynamically changed. This prediction function improves the user's input speed and realizes smooth operation while preventing erroneous selections.

In addition, since the selected characters or images are output as audio with natural pronunciation through an audio output unit or are visually displayed, the user can communicate both visually and audibly. This can provide a new means of communication for people with physical limitations to lead a more independent life, and can improve the efficiency of information processing in daily life.

A means for solving the problem of this disclosure is to provide a system comprising an eye-tracking unit, a display unit, an audio output unit, and an AI processing unit. The eye-tracking unit includes a sensor for detecting the movement of a user's eyes and identifying the direction of the gaze. Thereby, when the user selects a specific character or image, the selection is confirmed by fixating the gaze on the target for a certain period of time.

The display unit includes a screen for displaying selectable characters or images based on the user's gaze. This allows the user to make selections intuitively using their gaze. Furthermore, the audio output unit includes a speaker for outputting the selected characters or images as audio, and can convey the selected content to the surroundings.

The AI processing unit includes a machine learning algorithm for learning a user's past selection history and conversation history and predicting characters or images to be displayed on the display unit. This makes it possible to learn the user's personal preferences and daily conversation patterns, and to preferentially display frequently used words, phrases, and preferred images. This prediction function improves the user's input speed and realizes smooth operation while preventing erroneous selections.

By combining these components, a new means is provided that enables people with physical limitations to efficiently and quickly input information and communicate without using their hands.

The gaze tracking and AI processing in the present system are not capable of being performed as a human mental process, but are realized only by a specific hardware configuration and calculation algorithms. Specifically, for example, processing that applies a noise removal algorithm, such as a Kalman filter, to raw data of several hundred frames per second acquired from an infrared sensor to distinguish between a saccade (rapid eye movement) and a fixation in real time is physically impossible to perform via human brain calculation. Further, in order to minimize a movement distance of the user's gaze, the present system may perform GUI control to dynamically rearrange a next candidate word predicted by the AI within a predetermined radius (e.g., within a foveal visual region) from a current gaze position. This produces a technical effect of reducing ocular muscle fatigue of the user and improving the input efficiency, which is a function of the computer itself, as compared with a conventional static interface.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a communication assistance method based on gaze tracking.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

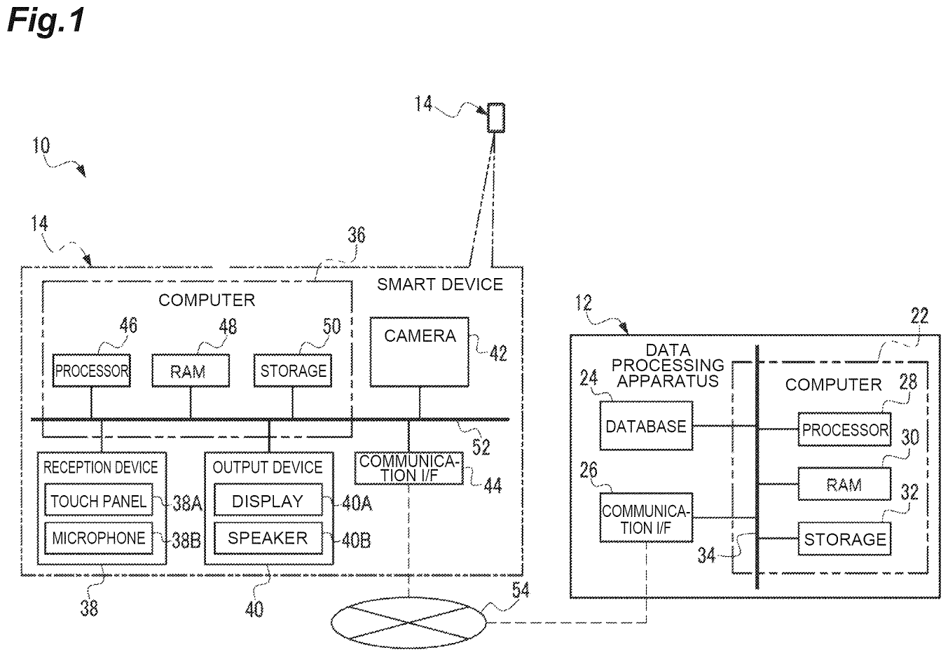

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

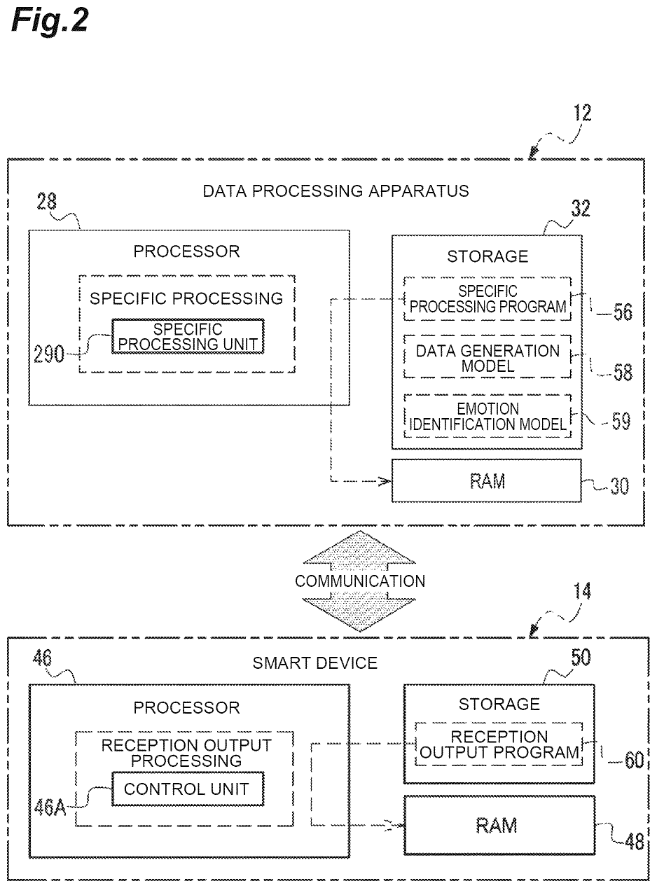

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

Distribution of processing load and reduction of latency in the data processing system 10 will be described in detail. The smart device 14 (or the smart glasses 214 or the headset 314) may be equipped with a dedicated processor for edge computing (e.g., an NPU: Neural Processing Unit or a DSP: Digital Signal Processor). This dedicated processor locally executes image recognition processing using a Convolutional Neural Network (CNN) on video data from the camera 42, extracts only gaze coordinate data, and transmits the extracted data to the data processing apparatus 12 (server). This avoids transmission of the entire video data, which requires a high bandwidth, thereby realizing saving of network bandwidth and reduction of communication latency. On the other hand, the data processing apparatus 12 handles next-word prediction processing, which imposes a high calculation load, using a Large Language Model (LLM) based on the received lightweight coordinate data and past history. This organic distributed hardware configuration realizes advanced inference processing while suppressing power consumption on the battery-driven terminal side.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

As an embodiment, a system configuration using a server and a terminal will be described in further detail. This system is composed of a terminal including an eye-tracking unit, a display unit, an audio output unit, and an AI processing unit, and a server that performs data processing and learning.

First, the terminal will be described. The terminal is realized as a goggle-type device worn by a user. The terminal may be configured by, for example, the smart glasses 214 or the headset-type terminal 314.

This terminal is equipped with an eye-tracking unit, which detects the movement and position of the user's pupils with high precision using an infrared camera or an optical sensor. The eye-tracking unit may be configured by, for example, the camera 42. The eye-tracking technology identifies the direction of the gaze in real time by analyzing the reflected light from the pupils. For example, when a user selects a specific character, the selection is confirmed by fixating the gaze on that character for a certain period of time. This time can be adjusted from about 0.5 seconds to 1 second according to the user's preference, realizing smooth operation while preventing erroneous selections.

Next, the display unit will be described. The display unit is a screen installed inside the goggles and displays selectable characters or images based on the user's gaze. The display unit may be configured by, for example, the display 343. The displayed content changes dynamically based on the user's past selection history and predictions by AI. For example, it is adjusted so that words and phrases frequently used by the user are preferentially displayed. In addition, pictures and images can also be displayed according to the user's preference. The screen has a high resolution and is coated with an anti-reflection coating to enhance visibility.

The audio output unit includes a speaker for outputting selected characters or images as audio. The audio output unit may be configured by, for example, the speaker 240. The audio output is performed with natural pronunciation using text-to-speech technology. This allows the user to convey the selected content to the surroundings. For example, when the user selects a greeting such as “hello,” that audio is output from the speaker. The audio output unit is provided with a function to automatically adjust the volume according to the ambient sound, and can lower the volume in a quiet place and raise the volume in a noisy place. This automatic adjustment function may be realized by a feedback loop that performs frequency analysis (FFT) on a waveform of the ambient sound picked up by a microphone in real time and controls a gain of an amplifier so as to maintain an S/N ratio (signal-to-noise ratio) at or above a certain level.

The AI processing unit performs initial data processing within the terminal, but mainly performs advanced learning and prediction in cooperation with the server. The AI processing unit may be configured by, for example, the specific processing unit 290, the specific processing program 56, the data generation model 58, the processor 46, and the control unit 46A. The server accumulates the user's selection history and conversation history, and learns the user's personal preferences and daily conversation patterns using a machine learning algorithm. For example, if a user has a tendency to use a specific phrase at a specific time of day, that pattern is learned and reflected in the display for subsequent times. The server analyzes complex patterns using a neural network and generates a customized prediction model for each user.

The server can also aggregate data from multiple users and extract common trends and patterns. This can improve the prediction accuracy for individual users. For example, it can learn phrases and words commonly used by users living in the same area and reflect them in each user's display. Furthermore, the server regularly updates the database and adds new words and phrases, thereby always providing the latest information.

In this way, by the terminal and the server cooperating, it is possible to improve the user's input speed and realize smooth operation while preventing erroneous selections. This provides a new means for people with physical limitations to efficiently and quickly input information and communicate without using their hands.

### (System Configuration)

The system according to the present embodiment comprises an eye-tracking unit, a display unit, an audio output unit, an AI processing unit, and a data processing server. These respective units operate in cooperation with each other to enable input using a user's gaze and to realize efficient information processing and communication.

The eye-tracking unit includes a sensor for detecting a user's eye movements and identifying a gaze direction. This unit analyzes the movement and position of the user's pupils with high precision using an infrared camera or an optical sensor. For example, it identifies the direction of the gaze in real time by capturing the reflected light from the pupils and tracking its changes. The eye-tracking unit has a function to confirm a selection by the user fixating their gaze on a target for a certain period of time when selecting a specific character or image. This time is adjustable according to the user's preference and realizes smooth operation while preventing erroneous selections. In addition, the eye-tracking unit analyzes the speed and pattern of the user's gaze movements and provides data for more accurately grasping the user's intention.

The display unit includes a screen for displaying selectable characters or images based on the user's gaze. This unit dynamically changes the displayed content based on the user's past selection history and predictions by AI. For example, it is adjusted so that words and phrases frequently used by the user are preferentially displayed. The display unit can also display pictures and images according to the user's preference and provides visual feedback. The screen has a high resolution and is coated with an anti-reflection coating to enhance visibility. Furthermore, the display unit has a function to optimize the arrangement of options according to the user's gaze movements.

The audio output unit includes a speaker for outputting selected characters or images as audio. This unit outputs the selected content as audio with natural pronunciation using text-to-speech technology. For example, when the user selects a greeting such as “hello,” that audio is output from the speaker. The audio output unit is provided with a function to automatically adjust the volume according to the ambient sound, and can lower the volume in a quiet place and raise the volume in a noisy place. In addition, the audio output unit supports multiple languages and can switch languages according to the user's selection.

The AI processing unit includes a machine learning algorithm for learning a user's selection history and conversation history and predicting characters or images to be displayed on the display unit. This unit performs advanced learning and prediction in cooperation with the server. For example, if a user has a tendency to use a specific phrase at a specific time of day, that pattern is learned and reflected in the display for subsequent times. The AI processing unit analyzes complex patterns using a neural network and generates a customized prediction model for each user. Furthermore, the AI processing unit has a function to continuously improve the prediction model by receiving feedback from the user.

The data processing server aggregates data from multiple users and extracts common trends and patterns. This server updates the model using the aggregated data to improve the prediction accuracy for individual users. For example, it can learn phrases and words commonly used by users living in the same area and reflect them in each user's display. The server also regularly updates the database and adds new words and phrases, thereby always providing the latest information.

Specific examples of prompt sentences to be read into a generative AI necessary for carrying out the present disclosure include “Develop an algorithm to predict selectable characters and images by analyzing user gaze data,” “Design a system to dynamically determine the next words or phrases to be displayed based on the user's selection history,” and “Implement a volume adjustment function according to ambient sound to improve the naturalness of audio output.” These prompts provide specific guidelines for the respective units of the system to operate in cooperation.

### (Implementation Steps)

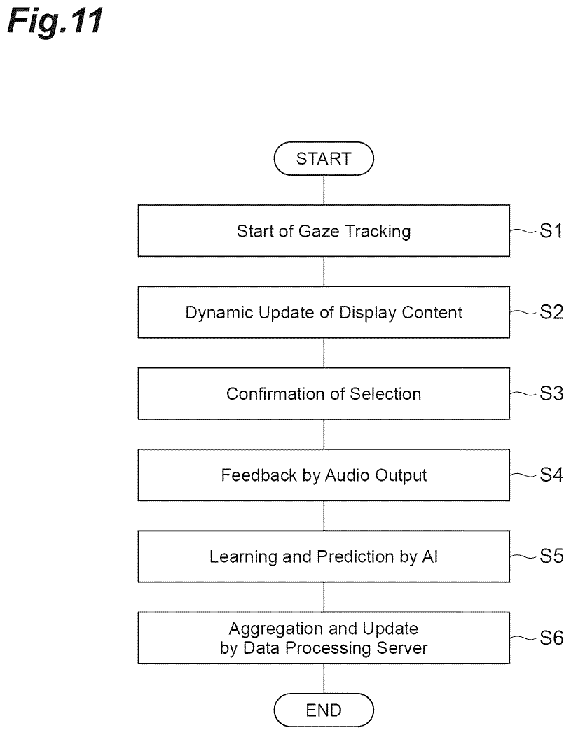

### Step 1: Start of Gaze Tracking (See Step S1 in FIG. 11)

When the user wears the goggle-type device, the eye-tracking unit activates and starts detecting the user's eye movements. It analyzes the movement and position of the pupils with high precision using an infrared camera or an optical sensor. This identifies the direction of the user's gaze in real time and determines which character or image the gaze is directed at. The eye-tracking unit also analyzes the speed and pattern of the user's gaze movements and provides data for more accurately grasping the user's intention.

### Step 2: Dynamic Update of Display Content (See Step S2 in FIG. 11)

Based on the data from the eye-tracking unit, the display unit displays characters or images on the screen according to the user's gaze. The displayed content changes dynamically based on the user's past selection history and predictions by AI. For example, it is adjusted so that words and phrases frequently used by the user are preferentially displayed. The display unit can also display pictures and images according to the user's preference and provides visual feedback.

### Step 3: Confirmation of Selection (See Step S3 in FIG. 11)

When the user selects a specific character or image, the selection is confirmed by fixating the gaze on the target for a certain period of time. This time can be adjusted from about 0.5 seconds to 1 second according to the user's preference, realizing smooth operation while preventing erroneous selections. When the selection is confirmed, that information is transmitted to the next step.

### Step 4: Feedback by Audio Output (See Step S4 in FIG. 11)

The selected characters or images are output as audio through the audio output unit. The selected content is output as audio with natural pronunciation using text-to-speech technology. The audio output unit is provided with a function to automatically adjust the volume according to the ambient sound, and can lower the volume in a quiet place and raise the volume in a noisy place. In addition, the audio output unit supports multiple languages and can switch languages according to the user's selection.

### Step 5: Learning and Prediction by AI (See Step S5 in FIG. 11)

The AI processing unit includes a machine learning algorithm for learning a user's selection history and conversation history and predicting characters or images to be displayed on the display unit. It performs advanced learning and prediction in cooperation with the server. For example, if a user has a tendency to use a specific phrase at a specific time of day, that pattern is learned and reflected in the display for subsequent times. Specific examples of prompt sentences to be read into the generative AI include “Develop an algorithm to predict selectable characters and images by analyzing user gaze data,” and “Design a system to dynamically determine the next words or phrases to be displayed based on the user's selection history.”

### Step 6: Aggregation and Update by Data Processing Server (See Step S6 in FIG. 11)

The data processing server aggregates data from multiple users and extracts common trends and patterns. This server updates the model using the aggregated data to improve the prediction accuracy for individual users. For example, it can learn phrases and words commonly used by users living in the same area and reflect them in each user's display. The server also regularly updates the database and adds new words and phrases, thereby always providing the latest information.

### (Specific Use Case)

For example, a case is assumed where a user for whom input using hands is difficult due to physical limitations wears a goggle-type device to communicate. This user selects characters or images with eye movements using the eye-tracking unit and inputs information. The eye-tracking unit detects the movement and position of the pupils with high precision using an infrared camera or an optical sensor and identifies the direction of the user's gaze in real time. This allows the user to confirm a selection by fixating their gaze on a specific character or image for a certain period of time.

The display unit displays selectable characters or images on the screen based on the user's gaze. The displayed content changes dynamically based on the user's past selection history and predictions by AI. For example, it is adjusted so that words and phrases frequently used by the user are preferentially displayed. This allows the user to efficiently input information.

The selected characters or images are output as audio through the audio output unit. The audio output is performed with natural pronunciation using text-to-speech technology and is provided with a function to automatically adjust the volume according to the ambient sound. This allows the user to convey the selected content to the surroundings.

The AI processing unit includes a machine learning algorithm for learning a user's selection history and conversation history and predicting characters or images to be displayed on the display unit. It performs advanced learning and prediction in cooperation with the server. For example, if a user has a tendency to use a specific phrase at a specific time of day, that pattern is learned and reflected in the display for subsequent times. Specific examples of prompt sentences to be read into the generative AI include “Develop an algorithm to predict selectable characters and images by analyzing user gaze data,” and “Design a system to dynamically determine the next words or phrases to be displayed based on the user's selection history.”

The data processing server aggregates data from multiple users and extracts common trends and patterns. This server updates the model using the aggregated data to improve the prediction accuracy for individual users. For example, it can learn phrases and words commonly used by users living in the same area and reflect them in each user's display. The server also regularly updates the database and adds new words and phrases, thereby always providing the latest information.

In this way, the system of the present disclosure utilizes eye-tracking technology and AI to provide a new means for a user with physical limitations to efficiently and quickly input information and communicate without using their hands.

(Application Example 1) A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

As an embodiment, a nursing care support system that utilizes eye-tracking technology and AI will be described in further detail. This system includes an eye-tracking unit, a display unit, an audio output unit, an AI processing unit, and a data processing server. These respective units operate in cooperation with each other to enable operation using a user's gaze and to realize efficient information processing and nursing care support.

The eye-tracking unit includes a sensor for detecting a user's eye movements and identifying a gaze direction. This unit analyzes the movement and position of the user's pupils with high precision using an infrared camera or an optical sensor. For example, it identifies the direction of the gaze in real time by capturing the reflected light from the pupils and tracking its changes. The eye-tracking unit has a function to confirm a selection by the user fixating their gaze on a target for a certain period of time when selecting a specific operation. This time is adjustable according to the user's preference and realizes smooth operation while preventing erroneous selections. In addition, the eye-tracking unit analyzes the speed and pattern of the user's gaze movements and provides data for more accurately grasping the user's intention. Furthermore, the eye-tracking unit records how frequently the user's gaze is directed in a specific direction and collects basic data for inferring the user's interests and concerns.

The display unit includes a screen for displaying selectable operations based on the user's gaze. This unit dynamically changes the displayed content based on the user's past selection history and predictions by AI. For example, it is adjusted so that operations frequently performed by the user are preferentially displayed. The display unit can display operation icons or menus according to the user's preference and provides visual feedback. The screen has a high resolution and is coated with an anti-reflection coating to enhance visibility. Furthermore, the display unit has a function to optimize the arrangement of options according to the user's gaze movements. For example, if a user frequently selects a specific operation, that operation can be placed in the center of the screen to make it more accessible.

The audio output unit includes a speaker for outputting a selected operation as audio. This unit outputs the selected content as audio with natural pronunciation using text-to-speech technology. For example, when the user selects to turn the lights on or off, audio confirming that operation is output from the speaker. The audio output unit is provided with a function to automatically adjust the volume according to the ambient sound, and can lower the volume in a quiet place and raise the volume in a noisy place. In addition, the audio output unit supports multiple languages and can switch languages according to the user's selection. Furthermore, the audio output unit has a function to adjust the tone and speed of the audio according to the user's auditory characteristics and provides optimal audio feedback for each individual user.

The AI processing unit includes a machine learning algorithm for learning a user's selection history and life patterns and predicting operations to be displayed on the display unit. This unit performs advanced learning and prediction in cooperation with the server. For example, if a user has a habit of turning on the lights at a specific time every day, that pattern is learned and reflected in the display for subsequent times. The AI processing unit analyzes complex patterns using a neural network and generates a customized prediction model for each user. Furthermore, the AI processing unit has a function to continuously improve the prediction model by receiving feedback from the user. For example, if a user erroneously selects a specific operation, that information is learned, and the prediction accuracy for subsequent times can be improved.

The data processing server aggregates data from multiple users and extracts common trends and patterns. This server updates the model using the aggregated data to improve the prediction accuracy for individual users. For example, it can learn operations and settings commonly used by users living in the same area and reflect them in each user's display. The server also regularly updates the database and adds new operations and settings, thereby always providing the latest information. Furthermore, the data processing server implements security measures and performs data encryption and access control to protect user privacy.

In this way, by the eye-tracking unit, the display unit, the audio output unit, the AI processing unit, and the data processing server cooperating, it is possible to improve the user's input speed and realize smooth operation while preventing erroneous selections. This provides a new means for people with physical limitations to efficiently and quickly input information and receive nursing care support without using their hands.

### (System Configuration)

The system according to the present embodiment comprises an eye-tracking unit, a display unit, an audio output unit, an AI processing unit, and a data processing server. This system operates with these components cooperating with each other, enabling operation using the user's gaze and realizing efficient information processing and nursing care support.

The eye-tracking unit includes a sensor for detecting a user's eye movements and identifying a gaze direction. This unit analyzes the movement and position of the user's pupils with high precision using an infrared camera or an optical sensor. For example, it identifies the direction of the gaze in real time by capturing the reflected light from the pupils and tracking its changes. The eye-tracking unit has a function to confirm a selection by the user fixating their gaze on a target for a certain period of time when selecting a specific operation. This time is adjustable according to the user's preference and realizes smooth operation while preventing erroneous selections. In addition, the eye-tracking unit analyzes the speed and pattern of the user's gaze movements and provides data for more accurately grasping the user's intention. Furthermore, the eye-tracking unit records how frequently the user's gaze is directed in a specific direction and collects basic data for inferring the user's interests and concerns.

The display unit includes a screen for displaying selectable operations based on the user's gaze. This unit dynamically changes the displayed content based on the user's past selection history and predictions by AI. For example, it is adjusted so that operations frequently performed by the user are preferentially displayed. The display unit can display operation icons or menus according to the user's preference and provides visual feedback. The screen has a high resolution and is coated with an anti-reflection coating to enhance visibility. Furthermore, the display unit has a function to optimize the arrangement of options according to the user's gaze movements. For example, if a user frequently selects a specific operation, that operation can be placed in the center of the screen to make it more accessible.

The audio output unit includes a speaker for outputting a selected operation as audio. This unit outputs the selected content as audio with natural pronunciation using text-to-speech technology. For example, when the user selects to turn the lights on or off, audio confirming that operation is output from the speaker. The audio output unit is provided with a function to automatically adjust the volume according to the ambient sound, and can lower the volume in a quiet place and raise the volume in a noisy place. In addition, the audio output unit supports multiple languages and can switch languages according to the user's selection. Furthermore, the audio output unit has a function to adjust the tone and speed of the audio according to the user's auditory characteristics and provides optimal audio feedback for each individual user.

The AI processing unit includes a machine learning algorithm for learning a user's selection history and life patterns and predicting operations to be displayed on the display unit. This unit performs advanced learning and prediction in cooperation with the server. For example, if a user has a habit of turning on the lights at a specific time every day, that pattern is learned and reflected in the display for subsequent times. The AI processing unit analyzes complex patterns using a neural network and generates a customized prediction model for each user. Furthermore, the AI processing unit has a function to continuously improve the prediction model by receiving feedback from the user. For example, if a user erroneously selects a specific operation, that information is learned, and the prediction accuracy for subsequent times can be improved.

The data processing server aggregates data from multiple users and extracts common trends and patterns. This server updates the model using the aggregated data to improve the prediction accuracy for individual users. For example, it can learn operations and settings commonly used by users living in the same area and reflect them in each user's display. The server also regularly updates the database and adds new operations and settings, thereby always providing the latest information. Furthermore, the data processing server implements security measures and performs data encryption and access control to protect user privacy.

Specific examples of prompt sentences to be read into a generative AI necessary for carrying out the present disclosure include “Develop an algorithm to predict the operation of smart home appliances by analyzing user gaze data,” “Design a system to dynamically determine the next necessary nursing care support based on the user's life patterns,” and “Implement a notification system using gaze input for a rapid response in an emergency.” These prompts provide specific guidelines for the respective units of the system to operate in cooperation.

### (Implementation Steps)

### Step 1: Start of Gaze Tracking

When the user wears the goggle-type device, the eye-tracking unit activates and starts detecting the user's eye movements. It analyzes the movement and position of the pupils with high precision using an infrared camera or an optical sensor. This identifies the direction of the user's gaze in real time and determines which operation the gaze is directed at. The eye-tracking unit also analyzes the speed and pattern of the user's gaze movements and provides data for more accurately grasping the user's intention.

### Step 2: Dynamic Update of Display Content

Based on the data from the eye-tracking unit, the display unit displays operations on the screen according to the user's gaze. The displayed content changes dynamically based on the user's past selection history and predictions by AI. For example, it is adjusted so that operations frequently performed by the user are preferentially displayed. The display unit displays operation icons or menus according to the user's preference and provides visual feedback.

### Step 3: Selection and Confirmation of Operation

When the user selects a specific operation, the selection is confirmed by fixating the gaze on the target for a certain period of time. This time can be adjusted from about 0.5 seconds to 1 second according to the user's preference, realizing smooth operation while preventing erroneous selections. When the selection is confirmed, that information is transmitted to the next step.

### Step 4: Feedback by Audio Output

The selected operation is output as audio through the audio output unit. The selected content is output as audio with natural pronunciation using text-to-speech technology. The audio output unit is provided with a function to automatically adjust the volume according to the ambient sound, and can lower the volume in a quiet place and raise the volume in a noisy place. In addition, the audio output unit supports multiple languages and can switch languages according to the user's selection.

### Step 5: Learning and Prediction by AI

The AI processing unit includes a machine learning algorithm for learning a user's selection history and life patterns and predicting operations to be displayed on the display unit. It performs advanced learning and prediction in cooperation with the server. For example, if a user has a habit of turning on the lights at a specific time every day, that pattern is learned and reflected in the display for subsequent times. Specific examples of prompt sentences to be read into the generative AI include “Develop an algorithm to predict the operation of smart home appliances by analyzing user gaze data,” and “Design a system to dynamically determine the next necessary nursing care support based on the user's life patterns.”

### Step 6: Aggregation and Update by Data Processing Server

The data processing server aggregates data from multiple users and extracts common trends and patterns. This server updates the model using the aggregated data to improve the prediction accuracy for individual users. For example, it can learn operations and settings commonly used by users living in the same area and reflect them in each user's display. The server also regularly updates the database and adds new operations and settings, thereby always providing the latest information.

### (Specific Use Case)

For example, a case is assumed where an elderly person for whom operation using hands is difficult due to physical limitations uses the system of the present disclosure to live their daily life. This elderly person wears a goggle-type device and controls the smart home appliances in their home using their gaze. The eye-tracking unit detects the movement and position of the user's pupils with high precision using an infrared camera and an optical sensor and identifies the direction of the gaze in real time. This allows the user to confirm operations such as turning lights on and off, changing television channels, adjusting the air conditioner temperature, and opening and closing curtains by fixating their gaze for a certain period of time.

The display unit displays selectable operations on the screen based on the user's gaze. The displayed content changes dynamically based on the user's past selection history and predictions by AI. For example, it is adjusted so that operations frequently used by the user are preferentially displayed. This allows the user to efficiently select necessary operations.

The selected operation is confirmed by audio through the audio output unit. The audio output unit outputs the selected content as audio with natural pronunciation using text-to-speech technology. The audio output unit is provided with a function to automatically adjust the volume according to the ambient sound, and can lower the volume in a quiet place and raise the volume in a noisy place. In addition, the audio output unit supports multiple languages and can switch languages according to the user's selection.

The AI processing unit learns the user's selection history and life patterns and predicts the next necessary operation. For example, if a user has a habit of turning on the lights at a specific time every day, it proposes to automatically turn on the lights when that time approaches. Specific examples of prompt sentences to be read into the generative AI include “Develop an algorithm to predict the operation of smart home appliances by analyzing user gaze data,” and “Design a system to dynamically determine the next necessary nursing care support based on the user's life patterns.”

The data processing server aggregates data from multiple users and extracts common trends and patterns. This server updates the model using the aggregated data to improve the prediction accuracy for individual users. For example, it can learn operations and settings commonly used by users living in the same area and reflect them in each user's display. The server also regularly updates the database and adds new operations and settings, thereby always providing the latest information.

In this way, the system of the present disclosure utilizes eye-tracking technology and AI to provide support for a user with physical limitations to efficiently and quickly input information and live a more independent daily life without using their hands.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

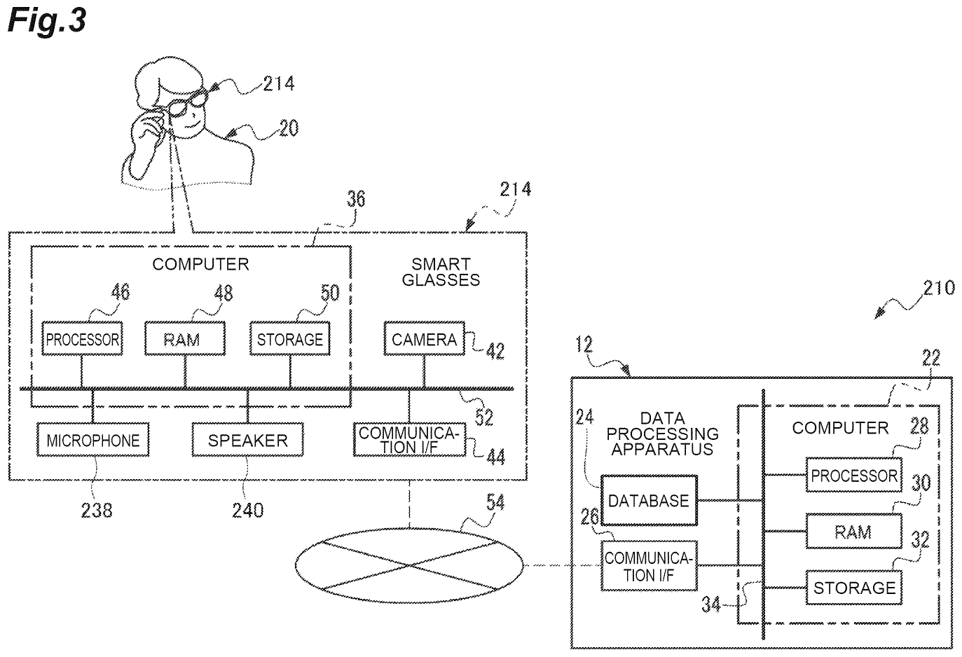

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

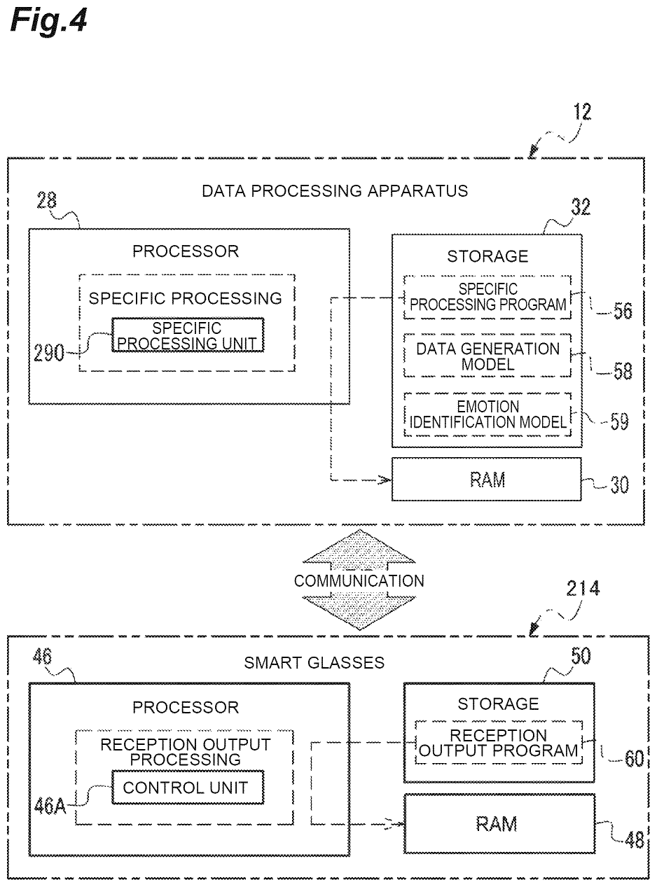

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

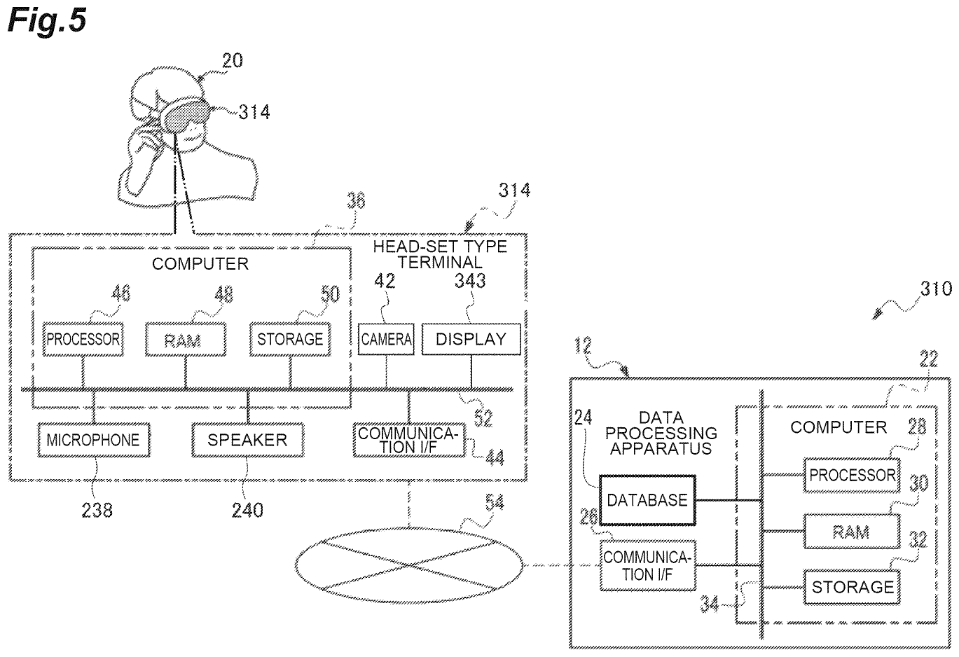

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

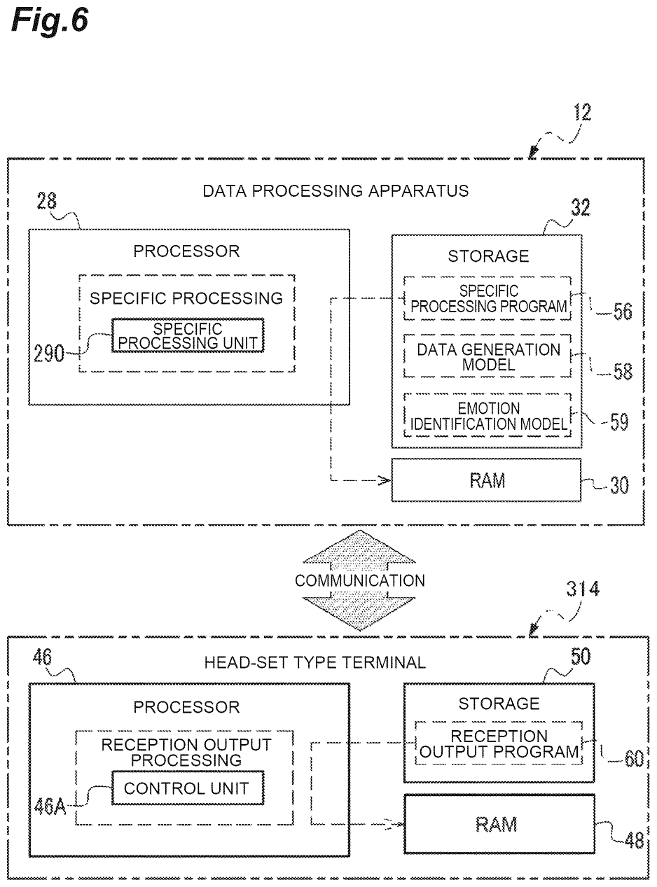

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14.

Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

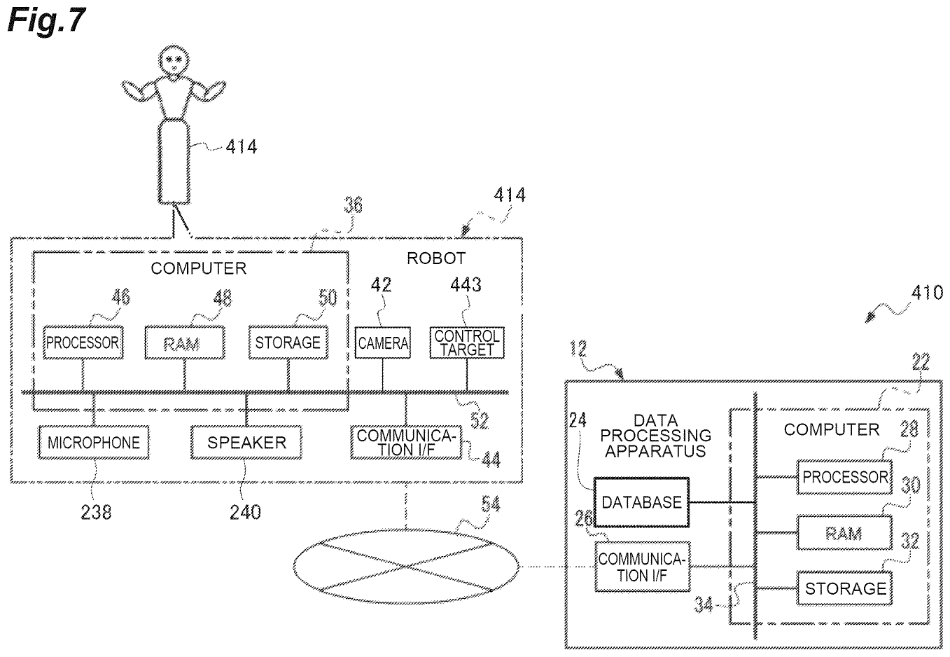

FIG. 7 illustrates an example of a configuration of a data processing system 410 according to a fourth embodiment.

As illustrated in FIG. 7, the data processing system 410 includes

a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a

WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

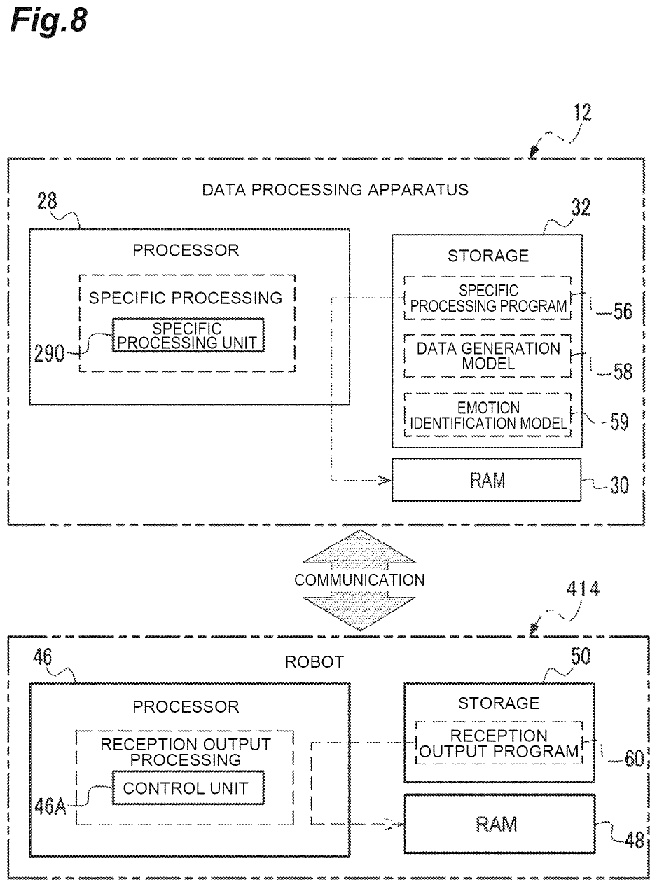

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48.

The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

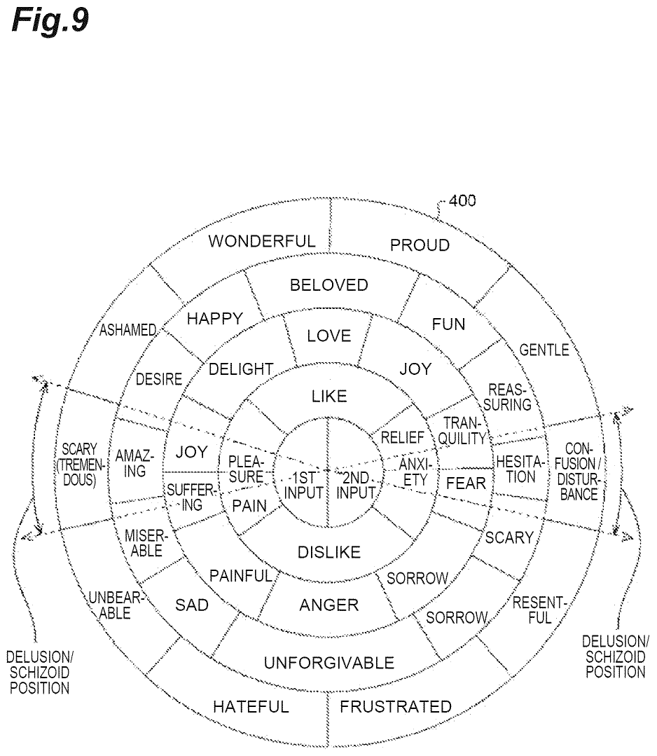

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

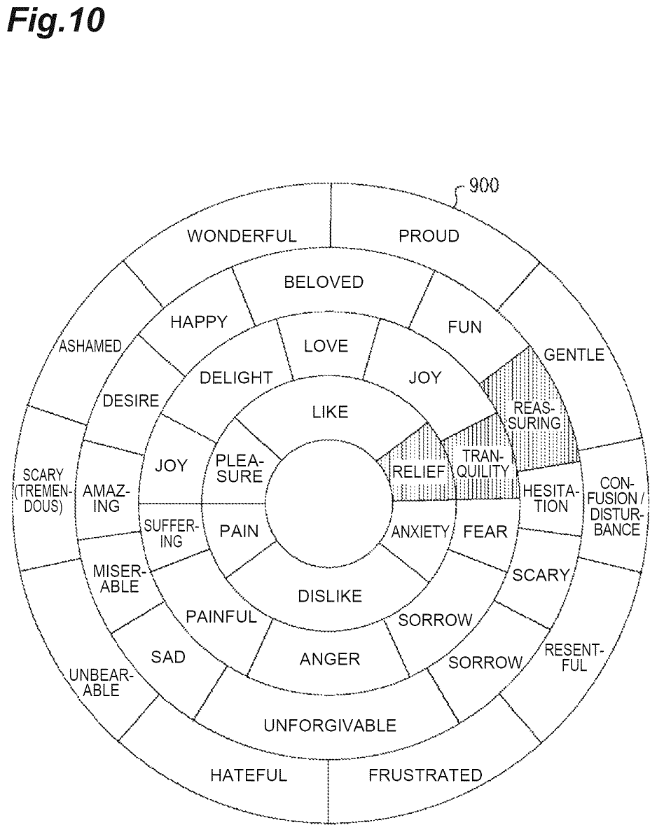

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system comprising an eye-tracking unit, a display unit, an audio output unit, an AI processing unit, and a data processing server. The eye-tracking unit includes a sensor for detecting a user's eye movements and identifying a gaze direction, the display unit includes a screen for displaying selectable operations based on the user's gaze, and the audio output unit includes a speaker for outputting selected operations as audio. The AI processing unit includes a machine learning algorithm for learning a user's past operation history and life patterns to predict a next necessary operation, and the data processing server includes a database for aggregating data from a plurality of users and extracting common trends and patterns to improve prediction accuracy. This enables a user with physical limitations to efficiently control a nursing care robot or a smart home appliance using their gaze.

The system, wherein the eye-tracking unit analyzes the movement and position of the user's pupils with high precision using an infrared camera and an optical sensor to identify the direction of the gaze in real time. This allows the user to confirm operations such as turning lights on and off, changing television channels, adjusting the air conditioner temperature, opening and closing curtains, and locking and unlocking doors by fixating their gaze for a certain period of time, realizing smooth operation while preventing erroneous selections.

The system, wherein the AI processing unit learns a user's life patterns and preferences and predicts a next necessary operation. For example, if a user has a habit of turning on the lights at a specific time every day, it proposes to automatically turn on the lights when that time approaches, and if a user watches a specific television program every week, it can automatically change the channel at that time. In addition, in an emergency, it is provided with a function that allows the user to quickly call for help using their gaze, and can automatically notify an emergency contact.

A communication assistance system based on gaze tracking, the system comprising: an image sensor; a display; a speaker; and circuitry, wherein the image sensor is configured to detect eye movement of a user, wherein the display is configured to display a character or an image selectable by the user, wherein the speaker is configured to output the character or the image selected by the user as audio, and wherein the circuitry is configured to: identify a direction of a gaze of the user; control the display to display the selectable character or image for the user to select based on the gaze of the user; control the speaker to output the selected character or image as the audio based on a selection result of the user; and learn, via a machine learning algorithm, a past selection history or a conversation history of the user and predict the character or the image to be displayed on the display for selection by the user.

The system, wherein the image sensor comprises an infrared camera and an optical sensor, wherein the infrared camera and the optical sensor are configured to detect movement and a position of a pupil of the user, and wherein the circuitry is configured to identify the direction of the gaze by analyzing the movement and the position of the pupil.

The system, wherein the circuitry is configured to learn a personal preference or a daily conversation pattern of the user, and dynamically change an option displayed on the display by predicting a word, a phrase, an image, or a video frequently used or preferred by the user.

A communication assistance method using a communication assistance system based on gaze tracking, the communication assistance system comprising an image sensor, a display, a speaker, and circuitry, the image sensor being configured to detect eye movement of a user, the display being configured to display a character or an image selectable by the user, the speaker being configured to output the character or the image selected by the user as audio, the method comprising: identifying a direction of a gaze of the user; controlling the display to display the selectable character or image for the user to select based on the gaze of the user; controlling the speaker to output the selected character or image as the audio based on a selection result of the user; and learning, via a machine learning algorithm, a past selection history or a conversation history of the user and predicting the character or the image to be displayed on the display for selection by the user.

1. A communication assistance system based on gaze tracking, the system comprising:
an image sensor;
a display;
a speaker; and
circuitry,
wherein the image sensor is configured to detect eye movement of a user,
wherein the display is configured to display a character or an image selectable by the user,
wherein the speaker is configured to output the character or the image selected by the user as audio, and
wherein the circuitry is configured to:
identify a direction of a gaze of the user;
control the display to display the selectable character or image for the user to select based on the gaze of the user;
control the speaker to output the selected character or image as the audio based on a selection result of the user; and
learn, via a machine learning algorithm, a past selection history or a conversation history of the user and predict the character or the image to be displayed on the display for selection by the user.

2. The system according to claim 1,
wherein the image sensor comprises an infrared camera and an optical sensor,
wherein the infrared camera and the optical sensor are configured to detect movement and a position of a pupil of the user, and
wherein the circuitry is configured to identify the direction of the gaze by analyzing the movement and the position of the pupil.

3. The system according to claim 1,
wherein the circuitry is configured to learn a personal preference or a daily conversation pattern of the user, and dynamically change an option displayed on the display by predicting a word, a phrase, an image, or a video frequently used or preferred by the user.

4. A communication assistance method using a communication assistance system based on gaze tracking, the communication assistance system comprising an image sensor, a display, a speaker, and circuitry, the image sensor being configured to detect eye movement of a user, the display being configured to display a character or an image selectable by the user, the speaker being configured to output the character or the image selected by the user as audio,
the method comprising:
identifying a direction of a gaze of the user;
controlling the display to display the selectable character or image for the user to select based on the gaze of the user;
controlling the speaker to output the selected character or image as the audio based on a selection result of the user; and
learning, via a machine learning algorithm, a past selection history or a conversation history of the user and predicting the character or the image to be displayed on the display for selection by the user.
